(19) United States
(12) Patent Application Publication
(10) Pub. No.: US 2026/0023538 A1
(43) Pub. Date: Jan. 22, 2026

(54) AGENT-BASED USER CUSTOM MODULE EXECUTING METHOD FOR WEB SYSTEM SERVERS

(71) Applicant: datamaker, Daejeon (KR)

(72) Inventor: Enoch Lee, Daejeon (KR)

(21) Appl. No.: 19/240,549

(22) Filed: Jun. 17, 2025

(30) Foreign Application Priority Data
Jul. 18, 2024 (KR) 10-2024-0095341

(51) Int. Cl. G06F 8/35

(52) U.S. Cl. CPC G06F 8/35

(57) ABSTRACT

A custom module executing method according to the present disclosure includes: (a) receiving, by a backend server, from a client terminal, a custom module ID identifying a custom module, an agent server ID identifying an agent server on which the custom module is to be executed, and an input value required for executing the custom module; (b) transmitting, by the backend server, the custom module ID and the input value to an agent server identified by the agent server ID; and (c) executing, by the agent server, the custom module identified by the custom module ID by using the input value. According to the present disclosure, even if a malicious code exists in a custom module executed by one agent server, all client terminals using the backend server are not affected by the malicious code, thereby significantly improving security of a system.

### CROSS REFERENCE TO RELATED APPLICATION

The present application claims priority to Republic of Korea Patent Application No. 10-2024-0095341 filed on Jul. 18, 2024. The entire contents of the above-listed application are hereby incorporated by reference for all purposes.

### TECHNICAL FIELD

The present disclosure relates to an agent-based user custom module executing method for web system servers that allows a user to use a custom module developed by a developer when developing artificial intelligence through a client terminal.

### BACKGROUND

Artificial intelligence development may not be performed uniformly, and the process and necessary elements may vary depending on the artificial intelligence to be developed. Therefore, in order to create a system capable of developing various types of artificial intelligence, the system should be designed so that its functions may be expanded according to user's requirements. When a user may configure functions necessary for the artificial intelligence he or she develops as a custom module and load and execute the functions in the system, the user may build an expandable artificial intelligence development system that may develop various types of artificial intelligence according to the purposes or situations he or she needs.

A custom module may be divided into a custom module executed on a client and a custom module executed on a server. The reason why an execution location of the custom module is divided into the client and the server is that the client mostly executes specific software such as a custom module through a web browser, but there are functions that the web browser may not execute due to technical limitations. The custom module that should be executed on the server, not the client, include an artificial neural network custom module, an artificial intelligence model custom module, a data preprocessing custom module, a data loading custom module, a data format change custom module, a data verification custom module, etc.

The client may not execute heavy operations such as the artificial neural network custom module (or the artificial intelligence model custom module) and the data preprocessing custom module (for example, dividing video data at each specific frame and creating image data).

With regard to a data loading custom module and a data format change custom module, since the data to be loaded or the data to be formatted are originally stored on the server, the client may not execute the data loading custom module and the data format change custom module.

In addition, with regard to the data verification custom module, there is a possibility that the client may forge and tamper data when executing the data verification custom module. Accordingly, when data is verified by the client and the verified data is transmitted to the server, the reliability of the data transmitted to the server is bound to be low. For this reason, the data verification custom module should be executed on the server, not the client, to prevent data from being forged and tampered.

FIG. 1 is a diagram illustrating a conventional custom module execution system 1. As illustrated in FIG. 1, the conventional custom module execution system 1 is composed of a custom module developer terminal 2, a backend server 3, and a client terminal 4.

The custom module developer terminal 2 may correspond to a computer or a smart terminal owned by a custom module developer, and may communicate with the backend server 3. The custom module developer terminal 2 may generate a custom module and transmit the generated custom module to the backend server 3.

The backend server 3 may store the custom module received from the custom module developer terminal 2. For example, the backend server 3 may store custom modules #1 to #5 received from the custom module developer terminal 2.

The client terminal 4 may correspond to a computer or a smart terminal owned by a user who wishes to execute a custom module on the backend server 3. The client terminal 4 may connect to the backend server 3 and confirm the custom modules #1 to #5 stored in the backend server 3, and for example, may request the backend server 3 to execute the custom module #1.

The backend server 3 may execute the custom module #1 according to the execution request of the client terminal 4, and when there is a result value according to the execution of the custom module #1, transmit the result value to the client terminal 4. In this case, the user may confirm the result value according to the execution of the custom module #1 through the screen of the client terminal 4.

However, since the backend server 3, which is a central processing unit, is not used by only one user but is shared by multiple users, the backend system code executed in the backend server 3 may affect all users.

Specifically, when a malicious code (e.g., SQL injection code) exists in the custom module that is executed by the backend server 3 and that is transmitted to the backend server 3 by the custom module developer terminal 2, all client terminals 4 may be affected by the malicious code. In other words, when the backend server 3 directly executes the custom module, the security of the system 1 may become very vulnerable.

In addition, when the custom module executed by the backend server 3 requires a very heavy operation (e.g., an operation to extract image data for each frame from 100 Gbyte video data), the performance of the backend server 3 with limited resources cannot help but be greatly reduced. As a result, users of a plurality of client terminals 4 that share the backend server 3 may not execute the custom module through the backend server 3, or even if they execute the custom module through the backend server 3, it takes too long to receive the result value.

Meanwhile, KR 10-2021-0047763 A (Apr. 30, 2021) discloses an artificial intelligence model management method and server in which an artificial intelligence model management server generates a container image using an artificial intelligence model when a user requests a container image from an artificial intelligence model management server.

### SUMMARY

The present disclosure provides a custom module executing method capable of solving problems of security vulnerability and performance degradation of a backend server that occur when a backend server directly executes a custom module.

However, the technical problem to be solved by the present disclosure is not limited to the above-described problem, and other problems not described can be clearly understood by those skilled in the art from the description of the disclosure described below.

According to an aspect of the present disclosure, a custom module executing method includes: (a) receiving, by a backend server, from a client terminal, a custom module ID identifying a custom module, an agent server ID identifying an agent server on which the custom module is to be executed, and an input value required for executing the custom module, the custom module being a custom module used for artificial intelligence development and a custom module selected by the client terminal; (b) transmitting, by the backend server, the custom module ID and the input value to an agent server identified by the agent server ID; and (c) executing, by the agent server, the custom module identified by the custom module ID by using the input value.

In (c), when the custom module identified by the custom module ID received from the backend server is already installed in the agent server, the agent server may execute the custom module already installed in the agent server by utilizing the input value, and when the custom module identified by the custom module ID received from the backend server is not installed in the agent server, the agent server may transmit the custom module ID received from the backend server to a custom module access information storage, receive custom module access information corresponding to the custom module ID from the custom module access information storage, access the custom module stored in the custom module storage through the custom module access information, installs the custom module, and then execute the custom module by utilizing the input value.

The backend server may receive the custom module access information from a custom module developer terminal, the custom module developer terminal being a terminal that stores the custom module in the custom module storage, and transmit the custom module access information to the custom module access information storage in order to transmit the custom module access information corresponding to the custom module ID to the agent server when the custom module access information storage receives the custom module ID from the agent server.

The backend server may receive the custom module ID and the custom module access information from a custom module developer terminal, the custom module developer terminal being a terminal that stores the custom module in the custom module storage, and transmit the custom module ID and the custom module access information to the custom module access information storage in order to transmit the custom module access information corresponding to the custom module ID to the agent server when the custom module access information storage receives the custom module ID from the agent server.

In (c), when the custom module identified by the custom module ID received from the backend server is already installed in the agent server, the agent server may execute the custom module already installed in the agent server by utilizing the input value, and when the custom module identified by the custom module ID received from the backend server is not installed in the agent server, the agent server transmit the custom module ID received from the backend server to the backend server, receive custom module access information corresponding to the custom module ID from the backend server, access the custom module stored in the custom module storage through the custom module access information, installs the custom module, and then execute the custom module by utilizing the input value.

The backend server may receive the custom module access information from a custom module developer terminal, the custom module developer terminal being a terminal that stores the custom module in the custom module storage, and generate the custom module ID corresponding to the custom module access information, and stores the custom module ID and the custom module access information in correspondence with each other, and transmit the custom module access information corresponding to the custom module ID to the agent server when receiving the custom module ID from the agent server.

The backend server may receive the custom module ID and the custom module access information from a custom module developer terminal, the custom module developer terminal being a terminal that stores the custom module in the custom module storage, store the custom module ID and the custom module access information in correspondence with each other, and transmit the custom module access information corresponding to the custom module ID to the agent server when receiving the custom module ID from the agent server.

The agent server may install the agent installation module received from the backend server, and when the installation of the agent installation module is completed on the agent server, transmit an agent server ID identifying the agent server to the backend server.

The custom module executing method may further include: after (c), (d) transmitting, by the agent server, a result value generated by executing the custom module to the backend server; and (e) transmitting, by the backend server, the result value to the client terminal.

### BRIEF DESCRIPTION OF FIGURES

FIG. 1 is a diagram illustrating a conventional custom module executing system.

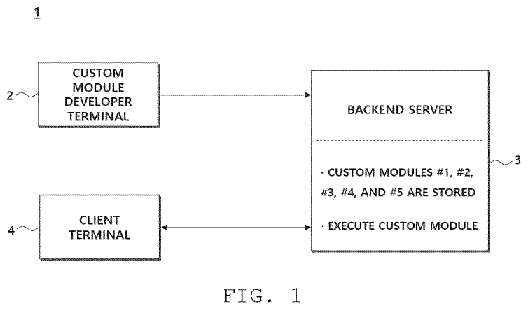

FIG. 2 is a flow chart of a custom module executing method according to the present disclosure.

FIG. 3 is a first embodiment of a custom module executing system that performs the method according to FIG. 2.

FIG. 4A is a diagram illustrating an example of a custom module #1 being stored in a custom module storage.

FIG. 4B is a diagram illustrating an example of a custom module #2 being stored in the custom module storage.

FIG. 5 is a diagram illustrating an example of an agent installation module being installed in an agent server.

FIG. 6 is a diagram illustrating an example of the agent server called ‘agent-staging’ that communicates with a backend server and monitored through the backend server.

FIG. 7 is a diagram illustrating an example of a list of custom modules displayed on a screen of a client terminal when a client terminal is connected to the backend server.

FIG. 8 is a diagram illustrating an example of a list of agent servers displayed on a screen of a client terminal when the client terminal is connected to the backend server.

FIG. 9 is a diagram illustrating an example of an input value description field displayed on the screen of the client terminal when the client terminal is connected to the backend server.

FIG. 10 is a modified example of FIG. 3 and a second embodiment of a custom module executing system that performs the method according to FIG. 2.

FIG. 11 is a modified example of FIG. 3 and a third embodiment of a custom module executing system that performs the method according to FIG. 2.

FIG. 12 is a modified example of FIG. 3 and a fourth embodiment of a custom module executing system that performs the method according to FIG. 2.

### DETAILED DESCRIPTION

Hereinafter, a custom module executing method according to the present disclosure will be described in detail with reference to the attached drawings. The accompanying drawings are provided by way of example in order to sufficiently transfer the spirit of the present disclosure to those skilled in the art, and the present disclosure is not limited to the accompanying drawing provided below, but may be implemented in another form. In this specification, unless otherwise specified, “including” any component means that other components may be further included rather than excluding other components.

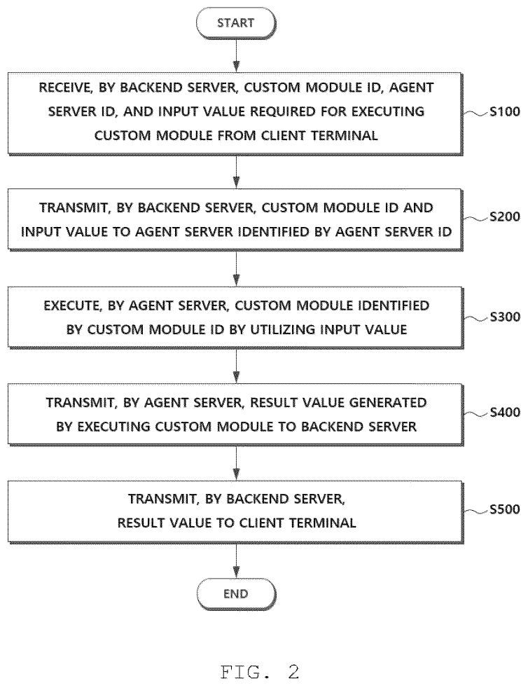

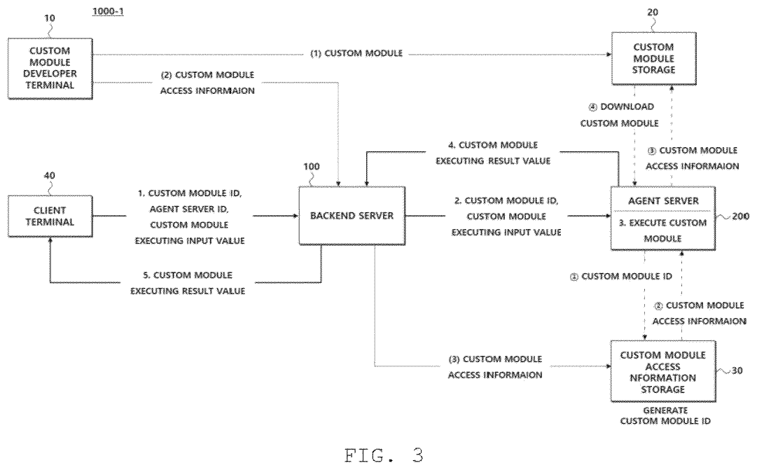

FIG. 2 is a flowchart of a custom module executing method according to the present disclosure, and FIG. 3 is a first embodiment of a custom module executing system 1000-1 that performs the method according to FIG. 2.

As illustrated in FIG. 3, the custom module executing method according to the present disclosure may be performed by a custom module developer terminal 10, a custom module storage 20, a custom module access information storage 30, a client terminal 40, a backend server 100, and an agent server 200.

In order for the components of the system 1000-1 illustrated in FIG. 3 to perform the method according to FIG. 2, a custom module should be stored in a custom module storage 20, and a process in which the custom module developer terminal 10 transmits custom module access information to the backend server 100 should be performed first.

To describe this in more detail, first, the custom module developer terminal 10 may generate the custom module that may be used for artificial intelligence development, and store the generated custom module in the custom module storage 20 (see ‘(1) Custom module’ of FIG. 3).

Here, the custom module developer terminal 10 may correspond to a computer or smart terminal owned by a custom module developer. There may be one or more custom module developer terminals 10, and there may also be one or more custom module storages 20. Any one custom module developer terminal 10 may store a custom module in one or more custom module storages among a plurality of custom module storages.

The custom module generated by the custom module developer terminal 10 is a module that may be used to develop the artificial intelligence, and refers to a module in which a plurality of software codes are gathered to perform meaningful functions related to artificial intelligence development. The types of custom modules may include an artificial neural network custom module, an artificial intelligence model custom module, a data preprocessing custom module, a data import custom module, a data format change custom module, a data verification custom module, etc.

Specifically, the artificial neural network custom module (or an artificial intelligence model custom module) refers to an artificial neural network (or an artificial intelligence model) developed by a developer for a specific purpose or situation. The data preprocessing custom module refers to a custom module related to a logic for preprocessing artificial intelligence-related data, and the data import custom module refers to a custom module related to a logic for importing artificial intelligence-related data. The data format change custom module refers to a custom module related to a logic for changing an artificial intelligence-related data format, and the data verification custom module refers to a custom module related to a logic for verifying artificial intelligence-related data.

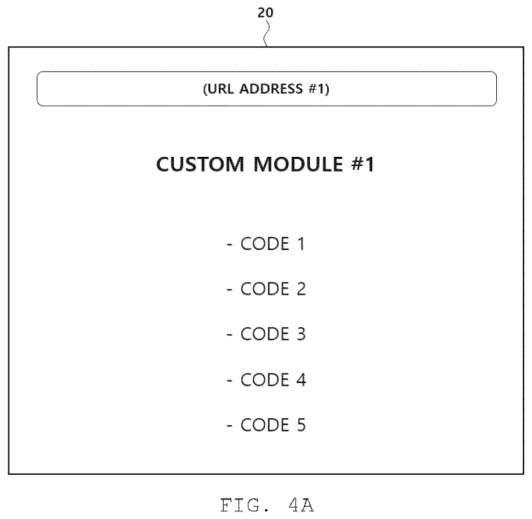

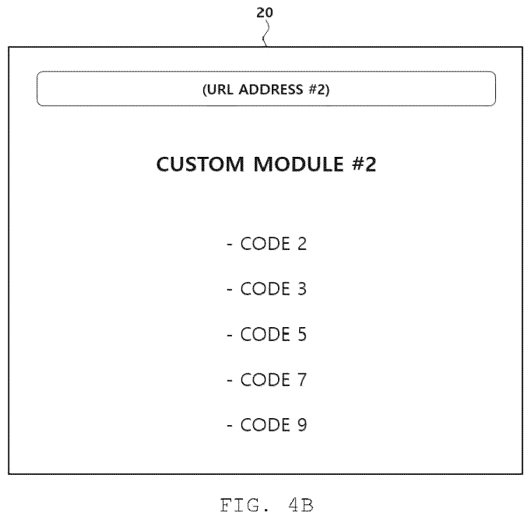

FIG. 4A is a diagram illustrating an example of custom module #1 being stored in the custom module storage 20, and FIG. 4B is a diagram illustrating an example of custom module #2 being stored in the custom module storage 20.

When the custom module developer terminal 10 generates the custom module #1, the custom module developer terminal 10 may store the custom module #1 in the custom module storage 20 as illustrated in FIG. 4A.

When the custom module developer terminal 10 stores the custom module #1 in the custom module storage 20, the custom module #1 may be stored in a specific uniform resource locator (URL) address (see URL address #1 of FIG. 4A) of the custom module storage 20.

In addition, when the custom module developer terminal 10 stores the custom module #1 in the custom module storage 20, a name of the custom module (i.e., custom module #1) and codes (i.e., code 1, code 2, code 3, code 4, and code 5) constituting the custom module #1 may be displayed at the URL address #1 of the custom module storage 20. The name and codes of the custom module may be designated by a developer who has the custom module developer terminal 10.

Similarly, when the custom module developer terminal 10 generates the custom module #2, the custom module developer terminal 10 may store the custom module #2 in the custom module storage 20 as illustrated in FIG. 4B.

When the custom module developer terminal 10 stores the custom module #2 in the custom module storage 20, the custom module #2 may be stored in the specific URL address (see URL address #2 of FIG. 4B) of the custom module storage 20.

In addition, when the custom module developer terminal 10 stores the custom module #2 in the custom module storage 20, the name of the custom module (i.e., custom module #2) and the codes (i.e., code 2, code 3, code 5, code 7, and code 9) constituting the custom module #2 may be displayed at the URL address #2 of the custom module storage 20. The name and codes of the custom module may also be designated by the developer possessing the custom module developer terminal 10.

The custom module developer terminal 10 may transmit the custom module access information to the backend server 100 after storing the custom module in the custom module storage 20 (see ‘(2) Custom module access information’ of FIG. 3).

The custom module access information transmitted by the custom module developer terminal 10 to the backend server 100 may include only the location information (e.g., URL address) of the custom module stored in the custom module storage 20.

Alternatively, the custom module access information transmitted by the custom module developer terminal 10 to the backend server 100 may include authentication information together with the location information (e.g., URL address). Here, the authentication information means information on an authority to download the custom module stored in the custom module storage 20. The form of the authentication information may be in the form of an ID and password set by the custom module developer terminal 10 in relation to the custom module storage 20, or in the form of an authentication key.

In the above example, the custom module developer terminal 10 may obtain the location information of the custom module #1 by a method such as copying the URL address (i.e., URL address #1) illustrated in FIG. 4A. Thereafter, the custom module developer terminal 10 may transmit the obtained location information (i.e., URL address #1) together with authentication information (i.e., information about the authority to download the custom module #1) to the backend server 100. In this case, the backend server 100 may store the location information and the authentication information as the custom module access information. Hereinafter, for the convenience of description, the custom module access information of the custom module #1 is referred to as the custom module access information #1.

Similarly, the custom module developer terminal 10 may obtain the location information of the custom module #2 by a method such as copying the URL address (i.e., URL address #2) illustrated in FIG. 4B. Thereafter, the custom module developer terminal 10 may transmit the obtained location information (i.e., URL address #2) together with authentication information (i.e., information about the authority to download the custom module #2) to the backend server 100. Even in this case, the backend server 100 may store the location information and the authentication information as the custom module access information. Hereinafter, for the convenience of description, the custom module access information of the custom module #2 is referred to as the custom module access information #2.

When the custom module developer terminal 10 transmits the custom module access information to the backend server 100, the custom module developer terminal 10 may transmit information on the name of the custom module, the codes constituting the custom module, functions of the custom module, etc., to the backend server 100. In this case, the backend server 100 may store the information.

The backend server 100 may receive the custom module access information from the custom module developer terminal 10 and then transmit the custom module access information to the custom module access information storage 30 (see ‘(3) Custom module access information’ of FIG. 3).

In the above example, the backend server 100 may transmit the custom module access information #1 and the custom module access information #2 received from the custom module developer terminal 10 to the custom module access information storage 30.

The reason why the backend server 100 transmits the custom module access information to the custom module access information storage 30 is to enable the custom module access information corresponding to the custom module ID to be transmitted to the agent server 200 when the custom module access information storage 30 receives a custom module identification (ID) from the agent server 200, as described below.

When the custom module access information storage 30 receives the custom module access information from the backend server 100, the custom module access information storage 30 may generate the custom module ID corresponding to the custom module access information. In the present disclosure, the custom module ID means an identifier that identifies the custom module that may be used for the artificial intelligence development.

The custom module access information storage 30 may generate the custom module ID and then store the custom module ID and the custom module access information in correspondence with each other. In addition, the custom module access information storage 30 may transmit the custom module ID and the custom module access information to the backend server 100. In this case, the backend server 100 may store the custom module ID and the custom module access information in correspondence with each other.

In the above example, when the custom module access information storage 30 receives the custom module access information #1 from the backend server 100, the custom module access information storage 30 may generate the custom module ID (referred to as ID 10) corresponding to the custom module access information #1. The custom module access information storage 30 may store ID 10 and the custom module access information #1 in correspondence with each other. In addition, the custom module access information storage 30 may transmit the ID 10 and the custom module access information #1 to the backend server 100. In this case, the backend server 100 may store the ID 10 and the custom module access information #1 in correspondence with each other.

When the custom module access information storage 30 receives the custom module access information #2 from the backend server 100, the custom module access information storage 30 may generate the custom module ID corresponding to the custom module access information #2 (referred to as ID 20). The custom module access information storage 30 may store ID 20 and the custom module access information #2 in correspondence with each other. In addition, the custom module access information storage 30 may transmit the ID 20 and the custom module access information #2 to the backend server 100. In this case, the backend server 100 may store the ID 20 and the custom module access information #2 in correspondence with each other.

In another embodiment, where the custom module access information storage 30 generates the custom module ID, the backend server 100 may generate the custom module ID instead of the custom module access information storage 30.

That is, when the backend server 100 receives the custom module access information from the custom module developer terminal 10, the backend server 100 may generate the custom module ID corresponding to the custom module access information. After generating the custom module ID, the backend server 100 may store the custom module ID and the custom module access information in correspondence with each other. In addition, when the backend server 100 transmits the custom module access information to the custom module access information storage 30, the custom module ID may be transmitted together. In this case, the custom module access information storage 30 may store the custom module ID and the custom module access information in correspondence with each other.

For example, when the backend server 100 receives the custom module access information #1 from the custom module developer terminal 10, the backend server 100 may generate the custom module ID (referred to as ID 10) corresponding to the custom module access information #1. The backend server 100 may store the ID 10 and the custom module access information #1 in correspondence with each other. In addition, the backend server 100 may transmit the custom module access information #1 to the custom module access information storage 30 together with the ID 10. In this case, the custom module access information storage 30 may store the ID 10 and the custom module access information #1 in correspondence with each other.

When the backend server 100 receives the custom module access information #2 from the custom module developer terminal 10, the backend server 100 may generate the custom module ID (referred to as the ID 20) corresponding to the custom module access information #2. The backend server 100 may store the ID 20 and the custom module access information #2 in correspondence with each other. In addition, the backend server 100 may transmit the custom module access information #2 to the custom module access information storage 30 together with the ID 20. In this case, the custom module access information storage 30 may store the ID 20 and the custom module access information #2 in correspondence with each other.

Meanwhile, in order for the agent server 200 to execute the custom module in response to a request (i.e., the backend server in step S200 described below transmits the custom module ID and the input value to the agent server identified by the agent server ID) for executing the custom module from the backend server 100, the agent server 200 should be able to receive a request for executing the custom module from the backend server 100 at any time. In other words, the agent server 200 should continuously communicate with the backend server 100. To this end, the agent server 200 may be connected to the backend server 100 and receive the agent installation module from the backend server 100. For example, the agent server 200 may be connected to the backend server 100, download the agent installation module provided in the backend server 100, and then install the agent installation module.

The agent server 200 according to the present disclosure may be a server owned or leased by the user of the client terminal 40, a server specifically designated by the user, or various other types of servers. In other words, there are no specific restrictions on the form that should be provided in order to become the agent server 200, and as long as the installation of the agent installation module is completed on any server, it may become the agent server 200 according to the present disclosure.

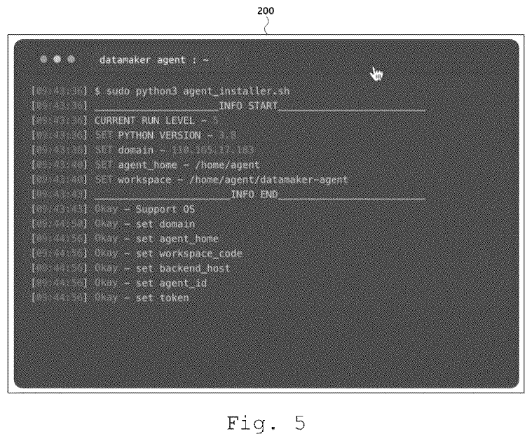

FIG. 5 is a diagram illustrating an example of an agent installation module being installed on the agent server 200. When the agent server 200 executes the agent installation module received from the backend server 100, the agent installation module is installed on the agent server 200 as illustrated in FIG. 5.

When the installation of the agent installation module in the agent server 200 is completed, the agent server 200 is automatically connected to the backend server 100, and the agent server ID that identifies the agent server 200 is automatically generated and stored in the agent server 200. In addition, the agent server ID may be transmitted from the agent server 200 to the backend server 100 and stored in the backend server 100.

Accordingly, when the backend server 100 receives a specific agent server ID from the client terminal 40 as in step S100 described below, the backend server 100 may identify a specific agent server 200 from the agent server ID, and may transmit the custom module ID and the input value to the identified agent server 200. In the present disclosure, the agent server ID means an identifier that identifies a specific agent server on which the custom module is to be executed.

In addition, when the installation of the agent installation module in the agent server 200 is completed, the agent server 200 is automatically connected to the backend server 100, so the agent server 200 may receive a request for executing the custom module from the backend server 100 at any time, and when there is a result value according to the execution of the custom module, the result value may be transmitted to the backend server 100 at any time.

In addition, when the installation of the agent installation module in the agent server 200 is completed, the backend server 100 may monitor the performance of the agent server 200 connected thereto and at least one of the custom modules installed in the agent server 200.

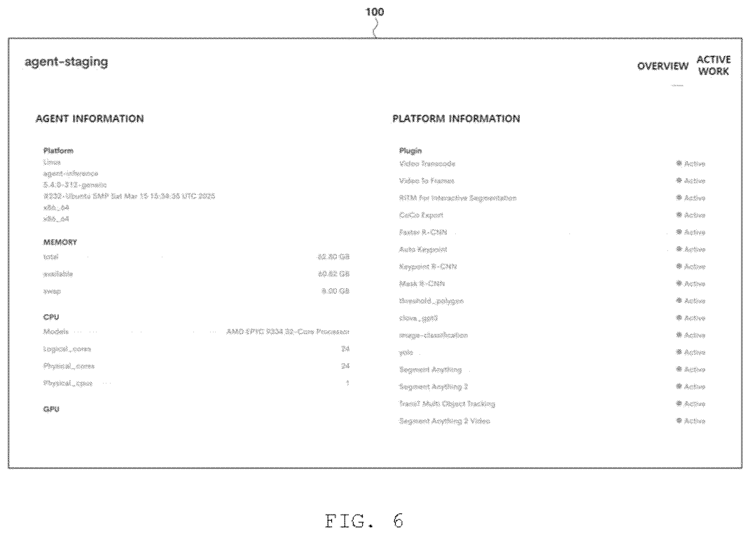

FIG. 6 is a diagram illustrating an example in which an agent server called ‘agent-staging’ connected to the backend server 100 is monitored through the backend server 100.

When the installation of the agent installation module in the agent-staging is completed, agent-staging is automatically connected to the backend server 100. In addition, as illustrated in FIG. 6, the backend server 100 may monitor the performance of the agent-staging (i.e., the platform, memory, CPU, GPU, etc., of agent-staging) and the custom modules (Video Transcode, Video To Frames, RITM For Interactive Segmentation, Faster R-CNN, Mask R-CNN, etc.) installed in the agent-staging.

Although FIG. 6 is an example in which the backend server 100 monitors only one agent server 200, the backend server 100 may monitor each of a plurality of agent servers 200. In this way, when the agent installation module is installed in the agent server 200, the backend server 100 may monitor the agent server 200, so an operator of the backend server 100 may manage the plurality of agent servers 200 at the same time, and may also take immediate action on the agent server 200 with a problem.

Meanwhile, according to the custom module executing method according to the present disclosure, a step in which the backend server 100 first receives a request for executing the custom module from the client terminal 40, that is, a step in which the backend server 100 receives the custom module ID, the agent server ID, and the input value required for executing the custom module, may be performed (S100).

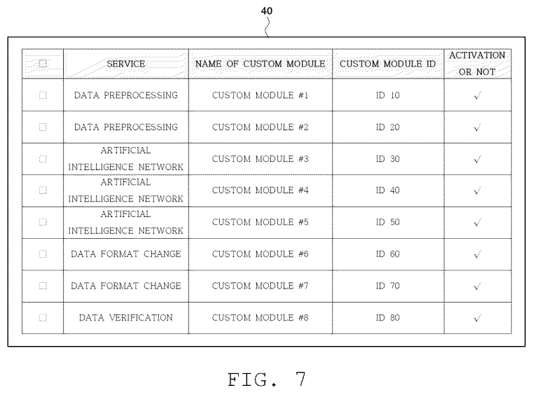

FIG. 7 is a diagram exemplarily illustrating a list of custom modules displayed on the screen of the client terminal 40 when the client terminal 40 is connected to the backend server 100.

The backend server 100 may provide a list of custom modules, such as that illustrated in FIG. 7, to the client terminal 40 by utilizing information about names (custom modules #1, #2, etc.) of custom modules, codes constituting the custom modules, and functions of the custom modules received from the custom module developer terminal 10. FIG. 7 is an example of listing names (custom modules #1 to #8) of a total of eight custom modules, and when the names of each custom module is clicked, the codes constituting each custom module and the description of the function of each custom module may be displayed on the screen of the client terminal 40.

The client terminal 40 may select the custom module (for example, selecting custom module #1 in FIG. 7) to be used for the artificial intelligence development. The fact that the client device 40 selects a custom module means that, from the perspective of the backend server 100, it receives the custom module ID from the client device 40 that identifies the selected custom module.

For example, when the client terminal 40 is connected to the backend server 100 and selects the custom module #1 from among the custom modules displayed on the screen of the client terminal 40, the backend server 100 receives the custom module ID (i.e., the ID 10) that identifies the custom module #1 from the client terminal 40.

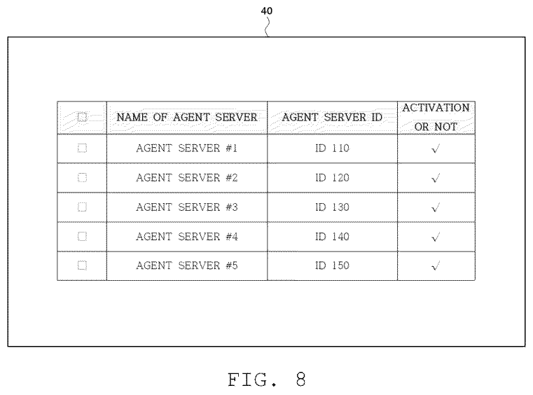

FIG. 8 is a diagram illustrating an example of a list of agent servers displayed on the screen of the client terminal 40 when the client terminal 40 is connected to the backend server 100.

The backend server 100 may provide a list of agent servers 200 such as FIG. 8 to the client terminal 40 by utilizing information about the names (agent server #1, agent server #2, etc.) of the agent servers 200 and the performance of the agent servers 200 connected thereto. FIG. 8 is an example in which the names (agent installation modules #1 to #5) of a total of five agent servers 200 are listed, and when the names of each agent server are clicked, the performance of each agent server may be displayed on the screen of the client terminal 40.

The client terminal 40 may select the agent server 200 on which the custom module will be executed (for example, select agent server #2 as the agent server 200 on which the custom module #1 will be executed). The fact that the client terminal 40 selects the agent server 200 means that the backend server 100 receives the agent server ID that identifies the selected agent server 200 from the client terminal 40.

For example, when the client terminal 40 is connected to the backend server 100 and selects agent server #2 from among the agent servers displayed on the screen of the client terminal 40, the backend server 100 receives the agent server ID (e.g., ID 120) that identifies agent server #2 from the client terminal 40.

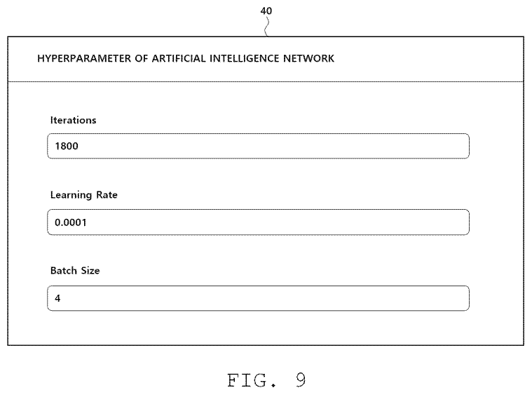

FIG. 9 is a diagram illustrating an example of an input value description field displayed on the screen of the client terminal 40 when the client terminal 40 is connected to the backend server 100. As illustrated in FIG. 9, when the client terminal 40 is connected to the backend server 100, the backend server 100 may provide the client terminal 40 with the input value description field in which the client terminal 40 may describe the input value required for executing the custom module.

The user of the client terminal 40 may describe the input value required for executing the custom module in the input value description field. Referring to FIG. 9, the user of the client terminal 40 may describe the input values in the ‘Iterations’, ‘Learning Rate’, and ‘Batch Size’ fields on the screen of the client terminal 40.

When the user of the client terminal 40 describes the input value in the input value description field and presses a transmit button (not illustrated), the backend server 100 receives the input value required for executing the custom module from the client terminal 40.

After the above step S100, the backend server 100 may transmit the custom module ID and the input value to the agent server 200 identified by the agent server ID (S200). In the above example, the backend server 100 may transmit the ID 10 and the input values required for executing the custom module #1 to an agent server #2 corresponding to an ID 120.

After the step S200, the agent server 200 may execute the custom module identified by the custom module ID by utilizing the input value (S300). In the above example, the agent server #2 may execute the custom module #1 identified by the ID 10 by utilizing the input value.

In this way, the present disclosure is configured so that, instead of the backend server 100 shared and used by the plurality of client terminals 40, the agent server 200 selected by the client terminal 40 executes the custom module. Accordingly, even when the malicious code exists in the custom module executed by a certain agent server 200, all client terminals 40 using the backend server 100 are not affected by the malicious code, and thus the security of the system may be significantly improved.

Meanwhile, in step S300, when the custom module identified by the custom module ID received from the backend server 100 is already installed in the agent server 200, the agent server 200 may execute the custom module already installed in the agent server 200 by utilizing the input value. However, when the custom module identified by the custom module ID received from the backend server 100 is not installed in the agent server 200, the agent server 200 should install the custom module in the agent server 200 in order to perform step S300.

To this end, the agent server 200 may transmit the custom module ID received from the backend server 100 to the custom module access information storage 30 (see ‘\textcircled{1} Custom module ID’ of FIG. 3).

The custom module ID and the custom module access information are stored in correspondence with each other in the custom module access information storage 30. Accordingly, when the custom module access information storage 30 receives the custom module ID (e.g., the ID 10) from the agent server 200, it may transmit the custom module access information (e.g., the custom module access information #1) corresponding to the custom module ID (the ID 10) to the agent server 200.

In other words, when the agent server 200 transmits the custom module ID (e.g., the ID 10) received from the backend server 100 to the custom module access information storage 30, the agent server 200 may receive the custom module access information (e.g., the custom module access information #1) corresponding to the custom module ID (the ID 10) from the custom module access information storage 30 (see ‘\textcircled{2} Custom module access information’ of FIG. 3).

As described above, the custom module access information may include the location information of the custom module stored in the custom module storage 20 and the authentication information, which is information about the authority to download the custom module stored in the custom module storage 20.

Accordingly, the agent server 200 may access the custom module (e.g., custom module #1) stored in the custom module storage 20 through the custom module access information (e.g., the custom module access information #1). Thereafter, the agent server 200 may be installed in the form of downloading and executing the custom module stored in the custom module storage 20 (refer to ‘\textcircled{3} Custom module access information’ and ‘\textcircled{4} Custom module’ of FIG. 3). When the installation of the custom module in the agent server 200 is completed, the agent server 200 may execute the custom module by utilizing the input value received from the backend server 100.

According to the present disclosure, the agent server 200 may easily identify the location where the custom module is stored through the custom module access information received from the custom module access information storage 30, and may execute the custom module in a relatively short time.

When the agent server 200 executes the custom module in step S300, the corresponding result value may be generated. In this case, the agent server 200 may transmit the result value generated by executing the custom module to the backend server 100 (S400).

After the above step S400, the backend server 100 may transmit the result value received from the agent server 200 to the client terminal 40 (S500). When the result value is transmitted to the client terminal 40, the user of the client terminal 40 may confirm the result value through the screen of the client terminal 40 and utilize the result value for the artificial intelligence development.

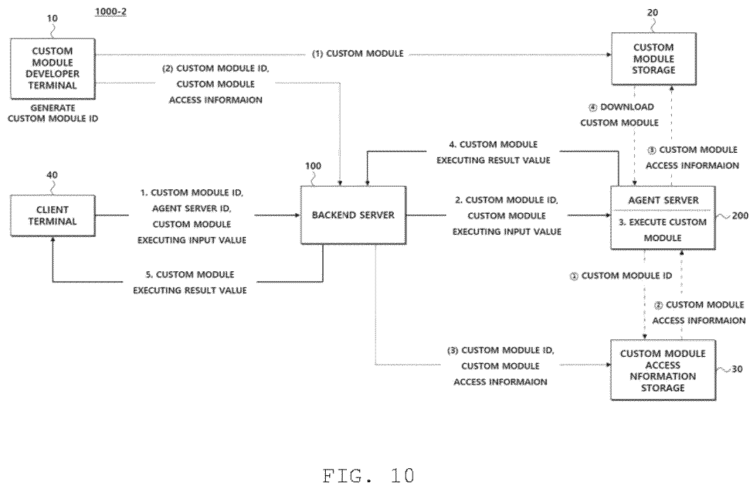

Meanwhile, FIG. 10 is a modified example of FIG. 3 and a second embodiment of a custom module executing system 1000-2 that performs the method according to FIG. 2. The second embodiment illustrated in FIG. 10 is different from the first embodiment illustrated in FIG. 3 in that the subject that generates the custom module ID is the custom module developer terminal 10.

In order for the components of the system 1000-2 illustrated in FIG. 10 to perform the method according to FIG. 2, a custom module should be stored in a custom module storage 20, and a process in which the custom module developer terminal 10 transmits the custom module ID and the custom module access information to the backend server 100 should be performed first.

To describe this in more detail, first, the custom module developer terminal 10 may generate the custom module that may be used for the artificial intelligence development, and store the generated custom module in the custom module storage 20 (refer to ‘(1) Custom module’ of FIG. 10), which is the same as described in FIG. 3.

Thereafter, the custom module developer terminal 10 may generate the custom module ID corresponding to the custom module access information, and transmit the custom module ID and the custom module access information to the backend server 100 (refer to ‘2 Custom module ID, custom module access information’ of FIG. 10). In this case, the backend server 100 may store the custom module ID and the custom module access information received from the custom module developer terminal 10 in correspondence with each other.

For example, when the custom module developer terminal 10 stores the custom module #1 in the custom module storage 20, the custom module developer terminal 10 may transmit the custom module access information #1 for accessing the custom module #1 stored in the custom module storage 20 to the backend server 100.

In addition, the custom module developer terminal 10 may generate the custom module ID, which is the ID 10 corresponding to the custom module access information #1, and may also transmit the ID 10 to the backend server 100. In this case, the backend server 100 may store the ID 10 and the custom module access information #1 in correspondence with each other.

Thereafter, the backend server 100 may transmit the custom module ID and the custom module access information received from the custom module developer terminal 10 to the custom module access information storage 30 (see ‘3 Custom module ID, the custom module access information’ of FIG. 10). In this case, the custom module access information storage 30 may store the custom module ID and the custom module access information in correspondence with each other.

For example, when the backend server 100 transmits the ID 10 and the custom module access information #1 to the custom module access information storage 30, the custom module access information storage 30 may store the ID 10 and the custom module access information #1 in correspondence with each other.

Here, the reason why the backend server 100 transmits the custom module ID and the custom module access information received from the custom module developer terminal 10 to the custom module access information storage 30 is to enable the custom module access information storage 30 to transmit the custom module access information corresponding to the custom module ID to the agent server 200 when receiving the custom module ID from the agent server 200.

That is, in the above step S300, when the custom module identified by the custom module ID is already installed in the agent server 200, the agent server 200 may execute the installed custom module by utilizing the input value. However, when the custom module identified by the custom module ID is not installed in the agent server 200, the agent server 200 should install the custom module in the agent server 200 in order to perform the step S300.

To this end, the agent server 200 may transmit the custom module ID received from the backend server 100 to the custom module access information storage 30 (see ‘\textcircled{1} Custom module ID’ of FIG. 10).

Referring to FIG. 10, the custom module ID and the custom module access information are stored in correspondence with each other in the custom module access information storage 30. Accordingly, when the custom module access information storage 30 receives the custom module ID (e.g., the ID 10) from the agent server 200, the custom module access information storage 30 may transmit the custom module access information (e.g., the custom module access information #1) corresponding to the custom module ID (e.g., the ID 10) to the agent server 200.

In other words, when the agent server 200 transmits the custom module ID (e.g., the ID 10) received from the backend server 100 to the custom module access information storage 30, the agent server 200 may receive the custom module access information (e.g., the custom module access information #1) corresponding to the custom module ID (e.g., the ID 10) from the custom module access information storage 30 (see ‘\textcircled{2} Custom module access information’ of FIG. 10).

The agent server 200 may access the custom module (e.g., custom module #1) stored in the custom module storage 20 through the custom module access information (e.g., the custom module access information #1). Thereafter, the agent server 200 may be installed in the form of downloading and executing the custom module stored in the custom module storage 20 (refer to ‘\textcircled{3} Custom module access information’ and ‘\textcircled{4} Custom module’ of FIG. 3). When the installation of the custom module in the agent server 200 is completed, the agent server 200 may execute the custom module by utilizing the input value received from the backend server 100.

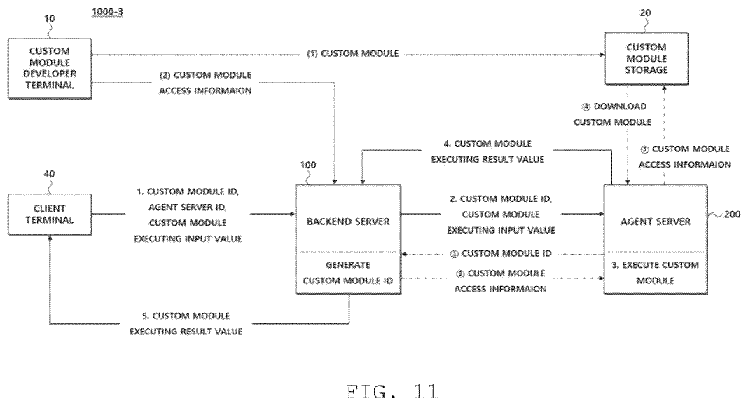

FIG. 11 is a modified example of FIG. 3 and a third embodiment of a custom module executing system 1000-3 that performs the method according to FIG. 2. The third embodiment illustrated in FIG. 11 is different from the first embodiment illustrated in FIG. 3 in that the custom module access information storage 30 is not provided.

In order for the components of the system 1000-3 illustrated in FIG. 11 to perform the method according to FIG. 2, a custom module should be stored in a custom module storage 20, and a process in which the custom module developer terminal 10 transmits custom module access information to the backend server 100 should be performed first.

To describe this in more detail, first, the custom module developer terminal 10 may generate the custom module that may be used for the artificial intelligence development, and store the generated custom module in the custom module storage 20 (refer to ‘(1) Custom module’ of FIG. 11), which is the same as described in FIG. 3.

Thereafter, the custom module developer terminal 10 may transmit the custom module access information to the backend server 100 (refer to ‘2 Custom module access information’ in FIG. 11). In this case, the backend server 100 may store the custom module access information.

For example, when the custom module developer terminal 10 stores the custom module #1 in the custom module storage 20, the custom module developer terminal 10 may transmit the custom module access information #1 for accessing the custom module #1 stored in the custom module storage 20 to the backend server 100. In this case, the backend server 100 may store the custom module access information #1.

When the backend server 100 receives the custom module access information from the custom module developer terminal 10, the backend server 100 may generate the custom module ID corresponding to the custom module access information. In addition, after generating the custom module ID, the backend server 100 may store the custom module ID and the custom module access information in correspondence with each other.

In the above example, when the backend server 100 receives the custom module access information #1 from the custom module developer terminal 10, the backend server 100 may generate the ID 10, which is the custom module ID corresponding to the custom module access information #1. In addition, the backend server 100 may store the ID 10 and the custom module access information #1 in correspondence with each other.

As described above, in step S300, when the custom module identified by the custom module ID received from the backend server 100 is already installed in the agent server 200, the agent server 200 may execute the custom module already installed in the agent server 200 by utilizing the input value. However, when the custom module identified by the custom module ID received from the backend server 100 is not installed in the agent server 200, the agent server 200 should install the custom module in the agent server 200 in order to perform step S300.

To this end, the agent server 200 may transmit the custom module ID received from the backend server 100 to the backend server 100 (see ‘\textcircled{1} Custom module ID’ of FIG. 11). Here, the agent server 200 transmitting the custom module ID to the backend server 100 means requesting the backend server 100 for the custom module access information.

According to the third embodiment according to FIG. 11, the backend server 100 stores the custom module ID and the custom module access information in correspondence with each other. Accordingly, when the backend server 100 receives the custom module ID (e.g., the ID 10) from the agent server 200, the backend server 100 may transmit the custom module access information (e.g., the custom module access information #1) corresponding to the custom module ID (e.g., the ID 10) to the agent server 200.

In other words, when the agent server 200 transmits the custom module ID (e.g., the ID 10) received from the backend server 100 to the backend server 100, the agent server 200 may receive the custom module access information (e.g., the custom module access information #1) corresponding to the custom module ID (e.g., the ID 10) from the backend server 100 (see ‘\textcircled{2} Custom module access information’ of FIG. 11).

The agent server 200 may access the custom module (e.g., custom module #1) stored in the custom module storage 20 through the custom module access information (e.g., the custom module access information #1). Thereafter, the agent server 200 may be installed in the form of downloading and executing the custom module stored in the custom module storage 20 (refer to ‘\textcircled{3} Custom module access information’ and ‘\textcircled{4} Custom module’ of FIG. 11). When the installation of the custom module in the agent server 200 is completed, the agent server 200 may execute the custom module by utilizing the input value received from the backend server 100.

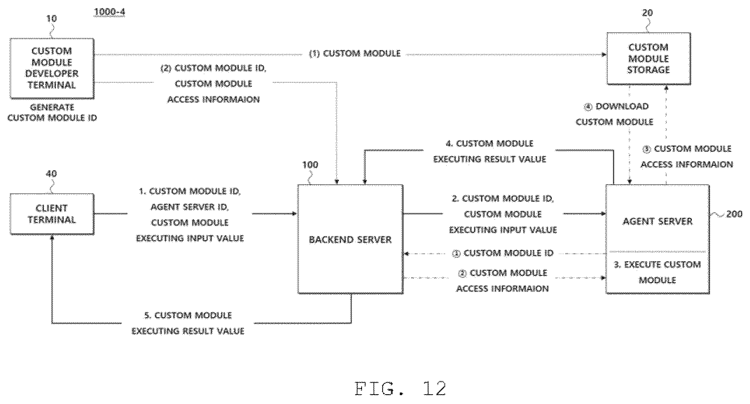

FIG. 12 is a modified example of FIG. 3 and a fourth embodiment of a custom module executing system 1000-4 that performs the method according to FIG. 2. The fourth embodiment illustrated in FIG. 12 is different from the first embodiment illustrated in FIG. 3 in that the custom module access information storage 30 is not provided and the subject that generates the custom module ID is the custom module developer terminal 10.

In order for the components of the system 1000-4 illustrated in FIG. 12 to perform the method according to FIG. 2, a custom module should be stored in a custom module storage 20, and a process in which the custom module developer terminal 10 transmits the custom module ID and the custom module access information to the backend server 100 should be performed first.

To describe this in more detail, first, the custom module developer terminal 10 may generate the custom module that may be used for the artificial intelligence development, and store the generated custom module in the custom module storage 20 (refer to ‘(1) Custom module’ of FIG. 12), which is the same as described in FIG. 3.

Thereafter, the custom module developer terminal 10 may generate the custom module ID corresponding to the custom module access information, and transmit the custom module ID and the custom module access information to the backend server 100 (refer to ‘2 Custom module ID, custom module access information’ of FIG. 12). In this case, the backend server 100 may store the custom module ID and the custom module access information received from the custom module developer terminal 10 in correspondence with each other.

For example, when the custom module developer terminal 10 stores the custom module #1 in the custom module storage 20, the custom module developer terminal 10 may transmit the custom module access information #1 for accessing the custom module #1 stored in the custom module storage 20 to the backend server 100.

In addition, the custom module developer terminal 10 may generate the custom module ID, which is the ID 10 corresponding to the custom module access information #1, and may also transmit the ID 10 to the backend server 100. In this case, the backend server 100 may store the ID 10 and the custom module access information #1 in correspondence with each other.

As described above, in the above step S300, when the custom module identified by the custom module ID is already installed in the agent server 200, the agent server 200 may execute the installed custom module by utilizing the input value. However, when the custom module identified by the custom module ID is not installed in the agent server 200, the agent server 200 should first install the custom module in the agent server 200 in order to perform the S300 step.

To this end, the agent server 200 may transmit the custom module ID received from the backend server 100 to the backend server 100 (see ‘\textcircled{1} Custom module ID’ of FIG. 12). Here, the agent server 200 transmitting the custom module ID to the backend server 100 means requesting the backend server 100 for the custom module access information.

According to the fourth embodiment according to FIG. 12, the backend server 100 stores the custom module ID and the custom module access information in correspondence with each other. Accordingly, when the backend server 100 receives the custom module ID (e.g., the ID 10) from the agent server 200, the backend server 100 may transmit the custom module access information (e.g., the custom module access information #1) corresponding to the custom module ID (e.g., the ID 10) to the agent server 200.

In other words, when the agent server 200 transmits the custom module ID (e.g., the ID 10) received from the backend server 100 to the backend server 100, the agent server 200 may receive the custom module access information (e.g., the custom module access information #1) corresponding to the custom module ID (e.g., the ID 10) from the backend server 100 (see ‘\textcircled{2} Custom module access information’ of FIG. 12).

The agent server 200 may access the custom module (e.g., custom module #1) stored in the custom module storage 20 through the custom module access information (e.g., the custom module access information #1). Thereafter, the agent server 200 may be installed in the form of downloading and executing the custom module stored in the custom module storage 20 (refer to ‘\textcircled{3} Custom module access information’ and ‘\textcircled{4} Custom module’ of FIG. 11). When the installation of the custom module in the agent server 200 is completed, the agent server 200 may execute the custom module by utilizing the input value received from the backend server 100.

The present disclosure is configured such that when the client terminal requests the backend server to execute the custom module (i.e., the backend server receives the custom module ID, the agent server ID, and the input value required for executing the custom module from the client terminal), the backend server requests the agent server to execute the custom module (i.e., the backend server transmits the custom module ID and the input value to the agent server), and the agent server executes the custom module identified by the custom module ID by utilizing the input value. According to the present disclosure, the backend server that is generally shared and used by the plurality of client terminals does not execute the custom module, but instead, the agent server selected by the client terminal (i.e., the agent server identified by the agent server ID) executes the custom module, so that even if the custom module executed by one agent server includes malicious code, all the client terminals using the backend server are not affected by the malicious code, thereby significantly improving the security of the system

In addition, according to the present disclosure, since the agent server selected by the client terminal executes the custom module instead of the backend server, it is possible to greatly reduce the possibility of the performance of the backend server being degraded.

In addition, according to the present disclosure, since the user of the client terminal may execute the custom module through the agent server of his/her choice, the custom module may be executed more reliably and at a faster speed than when the custom module is executed on the backend server. In other words, according to the present disclosure, when the user develops the artificial intelligence through the client terminal, it is possible to more conveniently use the custom module developed by the custom module developer.

In addition, according to the present disclosure, when the custom module developer generates the custom module that may not be executed on the client terminal but may be executed on the server (i.e., the agent server) through the custom module developer terminal, the user of the client terminal may execute the custom module through the agent server. According to the present disclosure, the environment for producing and consuming the custom module may be established, and as a result, the artificial intelligence development technology may be developed more rapidly.

However, the effects of the present disclosure are not limited to the above-described effects, and other effects that are not mentioned may be obviously understood by those skilled in the art from the above description.

Although the present disclosure has been described with reference to the exemplary embodiments and the accompanying drawings, it is not limited to the above-mentioned exemplary embodiments but may be variously modified and changed from the above description by those skilled in the art to which the present disclosure pertains. Therefore, the technical idea of the present disclosure should be understood only by the following claims, and all of the equivalences and equivalent modifications to the claims are intended to fall within the technical idea of the present disclosure.

What is claimed is:

1. A custom module executing method, comprising:
(a) receiving, by a backend server, from a client terminal, a custom module ID identifying a custom module, an agent server ID identifying an agent server on which the custom module is to be executed, and an input value required for executing the custom module, the custom module being a custom module used for artificial intelligence development and a custom module selected by the client terminal;
(b) transmitting, by the backend server, the custom module ID and the input value to the agent server identified by the agent server ID; and
(c) executing, by the agent server, the custom module identified by the custom module ID by using the input value.

2. The custom module executing method of claim 1, wherein, in (c),
when the custom module identified by the custom module ID received from the backend server is already installed in the agent server, the agent server executes the custom module already installed in the agent server by utilizing the input value, and
when the custom module identified by the custom module ID received from the backend server is not installed in the agent server, the agent server transmits the custom module ID received from the backend server to a custom module access information storage, receives custom module access information corresponding to the custom module ID from the custom module access information storage, accesses the custom module stored in the custom module storage through the custom module access information, installs the custom module, and then executes the custom module by utilizing the input value.

3. The custom module executing method of claim 2, wherein the backend server:
receives the custom module access information from a custom module developer terminal, the custom module developer terminal being a terminal that stores the custom module in the custom module storage, and
transmits the custom module access information to the custom module access information storage in order to transmit the custom module access information corresponding to the custom module ID to the agent server when the custom module access information storage receives the custom module ID from the agent server.

4. The custom module executing method of claim 2, wherein the backend server:
receives the custom module ID and the custom module access information from a custom module developer terminal, the custom module developer terminal being a terminal that stores the custom module in the custom module storage, and
transmits the custom module ID and the custom module access information to the custom module access information storage in order to transmit the custom module access information corresponding to the custom module ID to the agent server when the custom module access information storage receives the custom module ID from the agent server.

5. The custom module executing method of claim 1, wherein, in (c),
when the custom module identified by the custom module ID received from the backend server is already installed in the agent server, the agent server executes the custom module already installed in the agent server by utilizing the input value, and
when the custom module identified by the custom module ID received from the backend server is not installed in the agent server, the agent server transmits the custom module ID received from the backend server to the backend server, receives custom module access information corresponding to the custom module ID from the backend server, accesses the custom module stored in the custom module storage through the custom module access information, installs the custom module, and then executes the custom module by utilizing the input value.

6. The custom module executing method of claim 5, wherein the backend server:
receives the custom module access information from a custom module developer terminal, the custom module developer terminal being a terminal that stores the custom module in the custom module storage,
generates the custom module ID corresponding to the custom module access information, and stores the custom module ID and the custom module access information in correspondence with each other, and
transmits the custom module access information corresponding to the custom module ID to the agent server when receiving the custom module ID from the agent server.

7. The custom module executing method of claim 5, wherein the backend server:
receives the custom module ID and the custom module access information from a custom module developer terminal, the custom module developer terminal being a terminal that stores the custom module in the custom module storage,
stores the custom module ID and the custom module access information in correspondence with each other, and
transmits the custom module access information corresponding to the custom module ID to the agent server when receiving the custom module ID from the agent server.

8. The custom module executing method of claim 1, wherein the agent server:
installs the agent installation module received from the backend server, and
when the installation of the agent installation module is completed on the agent server, transmits an agent server ID identifying the agent server to the backend server.

9. The custom module executing method of claim 1, further comprising, after (c):
(d) transmitting, by the agent server, a result value generated by executing the custom module to the backend server; and
(e) transmitting, by the backend server, the result value to the client terminal.
